(19) United States
(12) Patent Application Publication
(10) Pub. No.: US 2011/0226753 A1
(43) Pub. Date: Sep. 22, 2011

(54) HOB COMPRISING A VISUAL DISPLAY UNIT AND METHOD FOR OPERATING A HOB

(75) Inventors: David Casanova Lacueva, Zaragoza (ES); Jose-Ramon Garcia Jimenez, Zaragoza (ES); Ignacio Garde Aranda, Zaragoza (ES); Carlos Vicente Mairal Serrano, Zaragoza (ES)

(73) Assignee: BSH BOSCH UND SIEMENS HAUSGERÄTE GMBH, Munich (DE)

(21) Appl. No.: 13/131,284

(22) PCT Filed: Nov. 10, 2009
(86) PCT No.: PCT/EP09/64934

§ 371 Date: May 26, 2011

(30) Foreign Application Priority Data
Dec. 1, 2008 (ES) P200803489

(51) Int. Cl. H05B 3/68

(52) U.S. Cl. 219/462.1

(57) ABSTRACT

A hob includes a visual display associating each heating zone on the hob with a control element in order to control heating zones that are variable. The visual display unit provides a user interface showing a pictogram of a heating zone that illustrates the position and/or the size of the heating zone, and a plurality of control elements are juxtaposed to the visual display unit. A detector detects the position and/or size of a cooking utensil. The control unit defines heating zones depending on the detected size and/or position of the cooking utensil element, associates one or more heating elements with the heating zone, and provides a symbol in the visual display that associates the pictogram of the heating zone with one of the control elements.

The invention relates to a hob comprising a visual display unit according to the preamble of claim 1 and to a method for operating such a hob according to the preamble of claim 6.

So-called matrix hobs comprising a plurality of heating elements which can be flexibly grouped into heating zones of various types are known from the prior art. The heating zones are adapted to the size and/or shape of a cooking utensil element which can be freely positioned on the hob by the operator. Because the hotplate area, which can also be changed by moving a saucepan, is freely selectable by the operator, permanently associating heating zones to control elements in order to adjust a heat output of these heating zones is very difficult or impossible. The use of touch screens for operating these heating zones is comparatively complicated, as the operator first has to select a heating zone whose settings are to be changed and then has to change the settings. Touch screens are also very expensive and difficult to operate, particularly with dirty fingers.

Furthermore, from DE 10 2007 008 896 A1, use of a touch screen in a user interface of a hob is known. This hob has a fixed hotplate area, and separate control elements, which are arranged separately from the touch screen, are provided for selecting the heating zone.

The object of the invention is in particular to design a hob of this kind such that it is simple and intuitive to operate without a touch screen having to be used.

The object is achieved in the features of the independent claims. Further advantageous embodiments and further developments of the invention will emerge from the sub claims.

The invention relates in particular to a hob comprising a plurality of heating elements which are arranged preferably in a grid comprising 4×4, 6×6 or 8×8 or more points. The otherwise uniform grid may be interrupted in an area of a user interface. The hob comprises furthermore a detector arrangement for detecting a position and/or size of a cooking utensil element and a control unit which defines a heating zone adapted to the position and/or size of the cooking utensil element and associates one or more heating elements with the heating zone. A user interface comprises a visual display unit comprising a plurality of control elements arranged adjacent to the visual display unit. The control unit comprises a driver for controlling the visual display unit and is programmed such that it generates in at least one operating mode a visual display which contains at least one pictogram of a heating zone. The pictogram illustrates a position and/or size of the heating zone.

In order to design an association of the heating zone with one of the control elements that is clear and simple, it is proposed that the visual display contain a symbol associated with the pictogram of the heating zone, which symbol associates the heating zone with one of the control elements. By this means, it can intuitively and simply be recognized which control element can be used for actuating and/or adjusting which heating zone, and mistakes can be avoided.

In a particularly preferred embodiment of the invention, the symbol is an arrow pointing to the control element and/or to the pictogram. The arrow may be single- or double-headed and take a plurality of conceivable forms. It is also conceivable for the symbol to be represented as a simple line or similar.

In a further embodiment of the invention, it is proposed that the symbol be embodied as a segment of a circle which is arranged concentrically with the pictogram. The circular segment represents an angular range in which the control element is arranged relative to a center point of the visual display. If the circular segment represents, for example, a top left sector of a circle or ring, it can intuitively be recognized that the top left switching element is associated with the heating zone concerned.

It is proposed furthermore that the control unit associate a control element with each heating zone and in addition calculate the distances from the pictograms of the heating zones to the control elements. The distances thus calculated are taken into account in the association. The control unit may additionally comprise both suitable software and specially adapted hardware with storage space for storing the various distances.

In a particularly preferred embodiment of the invention, it is proposed that the control unit calculate for each possible pairing between a free control element and a free pictogram a distance between the free pictogram and the free control element. The pairings are sorted by increasing or decreasing distance. The control unit selects the pairing with the shortest distance and associates the control element from the selected pairing with the pictogram of the selected pairing. The selected control element and the selected pictogram and/or the selected heating zone are then no longer “free” for the purposes of this method and all the pairings which comprise one of these elements are deleted from the list of pairings. The method is then repeated with the remaining pairings and/or the remaining free control elements and free pictograms until all the pictograms are associated with a control element.

A further aspect of the invention relates to a method for operating a hob comprising a plurality of heating elements. The method comprises the detection of a position and/or size of a cooking utensil element, the definition of at least one heating zone adapted to the cooking utensil element depending on the detected size and/or position of the cooking utensil element and the association of one or more heating elements with the heating zone. A visual display is generated on the visual display unit of a user interface. The user interface comprises a plurality of control elements arranged adjacent to the visual display unit. The visual display contains at least one pictogram of a heating zone, which pictogram illustrates a position and/or size of the heating zone on the hob.

In order to make an association between the heating zone and/or the pictogram and the control element intuitively recognizable, it is proposed that the visual display contain a symbol associated with the pictogram of the heating zone, which symbol associates the heating zone with one of the control elements.

Further advantages will emerge from the description of the drawings below. Exemplary embodiments of the invention are shown in the drawings. The drawings, the description and the claims contain numerous features in combination. Persons skilled in the art will usefully also examine the features individually and group them into further useful combinations.

FIG. 1 shows a hob comprising a plurality of heating elements, a control unit and a user interface,

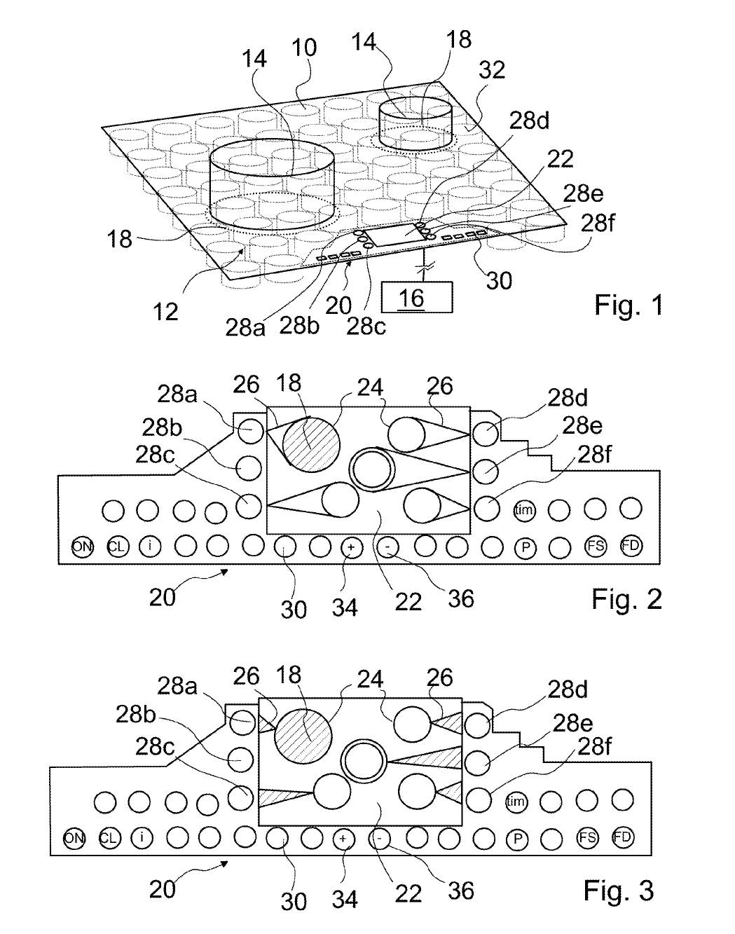

FIG. 2 shows the user interface from FIG. 1 in a first embodiment of the invention,

FIG. 3 shows the user interface according to an alternative embodiment of the invention and

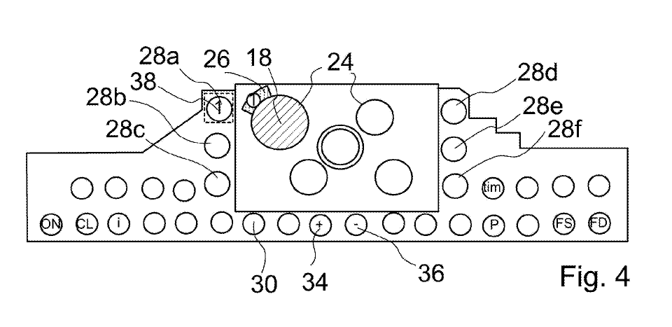

FIG. 4 shows the user interface of the hob according to a further alternative embodiment of the invention.

FIG. 1 shows a hob comprising a plurality of heating elements 10, a control unit 16 and a user interface 20. The control unit 16 operates the user interface and actuates the heating elements 10, which are embodied as inductors. The control unit 16 uses the heating elements 10 as inductive sensors for detecting cooking utensil elements 14 and groups those heating elements 10 which are covered at least partially by a base of the cooking utensil element 14 into a freely configurable heating zone 18 which is adapted in its size and position to the size and position of the cooking utensil element 14. The control unit 16 therefore forms together with the heating elements 10 a detector arrangement 12 for detecting a cooking utensil element 14. The user interface comprises a visual display unit 22 and a plurality of control elements 28a-28f arranged adjacent to the visual display unit, as well as further control elements 30 which are arranged on a front edge of the hob. Both the visual display unit 22 and the control elements are covered by a cover plate 32. The control elements 28a-28f are capacitive control elements which comprise sensors arranged immediately below the cover plate 32. The resolution of the visual display unit is at least 160×120 pixels.

During operation of the hob, the control unit 16 generates on the visual display unit 22 a visual display of the kind shown in FIG. 2. FIG. 2 shows an electronic circuit board of the user interface 20 without the cover plate 32. Both the visual display unit 22 and the sensors of the control elements 28a-28f are mounted on the electronic circuit board.

The visual display comprises one pictogram per heating zone 18 or per heated cooking utensil element 14. In the configuration shown in FIG. 2, five saucepans are placed on the hob so the control unit 16 defines five heating zones 18 which are represented as pictograms 24 in the form of circles on the visual display unit 22. A symbol 26 is associated with each pictogram 24, which symbol is embodied as an arrowhead which points from the pictogram 24 to one of the control elements 28a-28f and thus enables an optical association between the pictogram 24 and the control element 28a concerned. When the user actuates one of the control elements 28a, the pictogram 24 which is associated with this control element 28a via the symbol 26 is optically highlighted (for example by a full representation of the circle). A heat output of the heating zone 18 which is symbolized by the selected pictogram 24 can be increased via an increment key 34 or decreased via a decrement key 36 of the user interface 20.

FIG. 3 shows an alternative embodiment of the invention which differs from the embodiment according to FIG. 2 in the design of the symbols 26. In contrast to FIG. 2, the symbols 26 are arrows which point from the control elements 28a-28f to the respective pictogram 24.

FIG. 4 shows a further alternative embodiment of the invention, in which the symbols 26 are segments of a circle which are respectively arranged concentrically with the pictogram 24 with which the symbol 26 is associated. For reasons of simplicity, only one of the symbols 26 is shown in FIG. 4. The circular segment represents an angular range in which the control element is arranged relative to a center point of the visual display unit 22. In the exemplary embodiment shown in FIG. 4, the symbol 26 forms the top left part of a circular ring so it can intuitively be recognized by the user that the top left control element 28a is associated with the pictogram 24 concerned and/or the heating zone 18 concerned.

Furthermore, in the manner shown in FIG. 4, a numeral can be displayed on the symbol 26, which numeral corresponds to a numeral 38 which is imprinted on the cover plate 32 as a 7-segment display or as an imprint in the region of the control element 28a.

In order to associate the heating zones 18 and/or pictograms 24 with the various control elements 28a-28f, the control unit 16 defines a list of all the possible pairings of free control elements 28a-28f and pictograms 24. If M control elements and N pictograms are available, the result is M×N pairings. For each of these pairings the control unit 16 calculates a distance between an edge of the pictogram 24 and the control element 28a-28f of the pairing. To do this, the control unit 16 refers to a memory in which the positions of the control elements 28a-28f are stored as a two-dimensional vector relative to the plane of the visual display unit.

In the exemplary embodiment shown in FIGS. 2 and 3, in which the pictograms 24 are circles, the distance between the control element 28a-28f and the edge of the pictogram 24 is arrived at by subtracting a circle radius of the pictogram 24 from the distance of the center points of the control element 28a-28f concerned and of the pictogram 24. The control unit 16 sorts the distances determined in this way by size in a list and selects the pairing with the shortest distance.

The association between the control element 28a-28f and the pictogram 24 is established. In the exemplary embodiment shown in FIGS. 2-4, the association of the top left pictogram 24 with the top left control element 28a would accordingly be the first to be established. All the pairings which contain either the selected control element 28a or the selected pictogram 24 are then deleted from the list and again the pairing with the shortest distance is selected from the remaining pairings. This selection method is repeated until all the pictograms 24 are associated with one of the control elements 28a-28f.

### REFERENCE CHARACTERS

10 Heating element
12 Detector arrangement
14 Cooking utensil element
16 Control unit
18 Heating zone
20 User interface
22 Visual display unit
24 Pictogram
26 Symbol
28a-28f Control element
30 Control element
32 Cover plate
34 Increment key
36 Decrement key
38 Numeral

1-6. (canceled)

7. A hob, comprising:
a plurality of heating elements;
a detector adapted to detect at least one parameter selected from the group consisting of the position and the size of a cooking utensil;
a control unit adapted to define a heating zone using the detected parameter of the cooking utensil and to associate at least one heating element with the heating zone; and
a user interface having a visual display unit and a plurality of control elements arranged adjacent to the visual display unit, wherein in at least one operating mode of the visual display unit the control unit is adapted to generate a visual display including at least one pictogram of a heating zone that illustrates a parameter of the heating zone on the visual display unit, said visual display including a symbol associating the heating zone with one of the control elements.

8. The hob of claim 7, wherein the symbol is an arrow pointing to the one of the control elements.

9. The hob of claim 7, wherein, the symbol is an arrow pointing to the pictogram.

10. The hob of claim 7, wherein the symbol is a segment of a circle concentric with the pictogram, said circular segment representing an angular range in which the one of the control elements is positioned relative to a center point of the visual display unit.

11. The hob of claim 7, wherein the control unit is adapted to associate a control element with each heating zone, said control unit being adapted to calculate a distance from a pictogram of a heating zone to the control elements and use the distance in associating the heating zone with one of the control elements.

12. The hob of claim 11, wherein the control unit calculates a distance between a free pictogram and a free control element for each possible pairing between the free control element and the free pictogram, said control unit selecting the pairing having the shortest distance and associating the control element of the selected pairing with the pictogram of the selected pairing.

13. A method for operating a hob having a plurality of heating elements, said method comprising the steps of:
detecting a parameter selected from the group consisting of position and size of a cooking utensil;
defining a heating zone using the detected parameter of the cooking utensil;
associating at least one heating element with the heating zone; and
providing a user interface having a plurality of control elements arranged adjacent to a visual display unit, with the visual display unit providing a visual display including at least one pictogram of a heating zone that illustrates a parameter of the heating zone, and a symbol that associates the heating zone with one of the control elements.

14. The method of claim 13, wherein the symbol is an arrow pointing to the control element.

15. The method of claim 13, wherein the symbol is an arrow pointing to the pictogram.

16. The method of claim 13, wherein the symbol is a segment of a circle concentric with the pictogram, said circular segment representing an angular range in which the control element is positioned relative to a center point of the visual display unit.

17. The method of claim 13, further comprising the steps of calculating the distance from a pictogram of a heating zone to the control elements; and associating the heating zone with one of the control elements using these distances.

18. The method of claim 17, further comprising the steps of calculating a distance between a free pictogram and a free control element for each possible pairing between the free control element and a free pictogram; selecting the pairing having the shortest distance; and associating the control element of the selected pairing with the pictogram of the selected pairing.
